(19) United States
(12) Patent Application Publication
(10) Pub. No.: US 2021/0156374 A1
(43) Pub. Date: May 27, 2021

(54) OIL DETECTING DEVICE FOR COMPRESSOR AND COMPRESSOR INCLUDING OIL DETECTING DEVICE

(71) Applicant: LG ELECTRONICS INC., Seoul (KR)

(72) Inventors: Yoonsung CHOI, Seoul (KR); Jinho KIM, Seoul (KR); Sungyong AHN, Seoul (KR); Seheon CHOI, Seoul (KR); Mitsuhiro FUKUTA, Shizuoka (JP); Masaaki MOTOZAWA, Shizuoka (JP); Byeongchul LEE, Seoul (KR)

(73) Assignee: LG ELECTRONICS INC., Seoul (KR)

(21) Appl. No.: 17/059,411

(22) PCT Filed: May 28, 2019
(86) PCT No.: PCT/KR2019/006355

§ 371 Date: Nov. 27, 2020

(30) Foreign Application Priority Data
May 28, 2018 (KR) 10-2018-0060594
Nov. 9, 2018 (KR) 10-2018-0137658

(51) Int. Cl. F04B 49/22; G01F 23/14; F04B 51/00; F04B 39/02

(52) U.S. Cl. CPC F04B 49/22; F04B 39/0238; F04B 51/00; G01F 23/14

(57) ABSTRACT

An oil detecting device for a compressor and a compressor including an oil detecting device are provided. A casing in which oil is received has a plurality of capillary tubes in an inner space of the casing, and a condition of oil is detected on the basis of a result of a measured pressure from the plurality of capillary tubes.

### CROSS-REFERENCE TO RELATED APPLICATIONS

This application is a National Stage filing under 35 U.S.C. 371 of International Application No. PCT/KR2019/006355, filed on May 28, 2019, which claims the benefit of earlier filing date and right of priority to Korean Application Nos. 10-2018-0060594, filed May 28, 2018 and 10-2018-0137658, filed Nov. 9, 2018, the contents of which are incorporated by reference herein in its entirety.

### TECHNICAL FIELD

An oil detecting (or detection) device that senses a condition of oil received in a compressor, and a compressor including an oil detecting device are disclosed herein.

### BACKGROUND

In general, compressors are hermetic compressors having an electric motor unit that generates a drive force in an inner space of a hermetically sealed casing and a compression unit that compresses a gas using the drive force transmitted from the electric motor unit. A certain amount of oil is filled in a casing of a hermetic compressor to lubricate a compression unit or cool the electric motor unit. Some of this oil is controlled to always maintain a predetermined level of oil while circulating through a refrigeration cycle including the compression unit. However, some of the oil flowing through the refrigeration cycle may not be recovered due to various factors. This may result in damage to the compression unit as the compressor is operated under adverse driving conditions. Therefore, an appropriate amount of oil should be maintained in the casing to increase a lifespan and operating efficiency of the compressor.

However, in recent years, compressor structure has become increasingly complex, and compressors have been widely used in large-sized air conditioners or systems, which makes proper control of an oil level in the compressor difficult as a pipe through which oil and a working fluid flow increase in length. In particular, when the pipe size is increased, an amount of oil remaining in the pipe increases, and thus, an amount of oil stored in an oil storage space during operation or use changes significantly and irregularly even though an appropriate amount of oil is supplied initially.

For this reason, it is necessary to continuously or periodically check an oil level in a storage space. When it is determined that the oil level is below an appropriate level, an oil recovery operation to collect oil into a compressor should be performed. The oil level can be visually checked through a transparent window provided at a casing of the compressor. However, this is economically inefficient, and thus, in reality, the oil recovery operation is performed on a regular basis regardless of the oil level. However, in some cases, an oil recovery operation may be forcibly performed even if an oil level is sufficient, which is inefficient as it consumes unnecessary energy.

Korean Patent Laid-Open Application No. 10-2015-0086082, published on Jul. 27, 2017, which is hereby incorporated by reference, discloses a configuration for performing an oil recovery operation. In that publication, an oil level sensor is separately installed at a casing of a compressor, and the oil recovery operation is performed according to an oil level detected by the oil level sensor. This is efficient as an unnecessary oil recovery operation can be reduced, and thereby reduces energy consumption and increases a compressor operation time. However, in the case of sensing oil using the related art oil level sensor, the presence and absence of oil can be checked only at a position at which the oil level sensor is provided. In addition, due to the nature of the oil level sensor, the oil level cannot be checked in real time, and physical properties of oil cannot be measured.

### SUMMARY

Embodiments disclosed herein provide an oil detecting device capable of detecting physical properties of oil, and a compressor including an oil detecting device.

Embodiments disclosed herein also provide an oil detecting device capable of detecting an oil level in real time, and a compressor including an oil detecting device.

Embodiments disclosed herein further provide an oil detecting device capable of addressing structural or design limitations in detecting oil, and a compressor including an oil detecting device.

Embodiments disclosed herein furthermore provide an oil detecting device equipped with a detection element that can properly and correctly detect physical properties of oil and an oil level in real time, and a compressor including an oil detecting device.

Embodiments disclosed herein provide an oil detecting device that detects a condition of oil using a plurality of capillary tubes and a compressor including an oil detecting device. That is, the oil detecting device and the compressor including the oil detecting device disclosed herein are provided with the plurality of capillary tubes in an inner space of a casing in which oil is accommodated, so as to detect the condition of the oil based on results of a pressure measurement of the plurality of capillary tubes.

This technical feature may be applied to an oil detecting device for a compressor or a compressor including an oil detecting device to solve the above-described problems.

According to embodiments disclosed herein, an oil detecting device for a compressor includes a sensing unit or sensor that includes a plurality of capillary tubes disposed at an inner space of a casing of the compressor in which a specific or predetermined amount of oil is accommodated to be in contact with the oil, a regulating unit or regulator connected to each of the plurality of capillary tubes to adjust a pressure of the plurality of capillary tubes so that the oil is introduced into the plurality of capillary tubes, and a detection unit or detector electrically connected to the sensing unit and the regulating unit to measure the pressure of the plurality of capillary tubes, adjusted by the regulating unit, so as to detect a condition of the oil based on results of the pressure measurement.

Embodiments disclosed herein may include one or more of the following features. For example, an end of at least one of the plurality of capillary tubes may have a different height (depth) based on an oil level of the oil.

At least one of the plurality of capillary tubes may have a smaller inner diameter. At least two capillary tubes of the plurality of capillary tubes may have different inner diameters, and the plurality of capillary tubes may be formed such that a capillary tube having a smaller inner diameter has a lower height from the oil level than a capillary tube having a larger inner diameter. The plurality of capillary tubes may be disposed in a horizontal or vertical direction with respect to an oil level of the oil.

The sensing unit may further include a terminal coupled to one surface of the casing so as to be connected to the plurality of capillary tubes and the regulating unit. The plurality of capillary tubes may be detachably connected to the terminal.

The regulating unit may include a pump configured to adjust the pressure of the plurality of capillary tubes, and a valve configured to control a flow path that connects the pump and the sensing unit. The valve may selectively control flow paths connecting the pump and the respective capillary tubes.

The detection unit may be configured to control the pressure adjustment by controlling operation of the regulating unit. The detection unit may include a measuring part that measures the pressure of the plurality of capillary tubes.

The detection unit may detect the condition of the oil by analyzing results of the pressure measurement of the plurality of capillary tubes. The detection unit may detect at least one of density, an oil level, or surface tension of the oil by analyzing results of the pressure measurement of the plurality of capillary tubes.

According to another embodiment disclosed herein, an oil detecting device for a compressor includes a plurality of capillary tubes horizontally disposed at an inner space of a casing of the compressor in which a specific or predetermined amount of oil is accommodated to be in contact with the oil, a terminal insertedly coupled to one surface of the casing in a manner of penetrating through the one surface of the casing so as to be connected to the plurality of capillary tubes at the inner space, a regulating unit or regulator connected to each of the plurality of capillary tubes through the terminal to adjust pressure of the plurality of capillary tubes so that the oil is introduced into the plurality of capillary tubes, and a detection unit or detector electrically connected to the plurality of capillary tubes and the regulating unit through the terminal to measure the pressure of the plurality of capillary tubes, adjusted by the regulating unit, so as to detect condition of the oil based on results of the pressure measurement.

Embodiments disclosed herein may include one or more of the following features. For example, an end of at least of the plurality of capillary tubes may have a different height (depth) based on an oil level of the oil.

At least one of the plurality of capillary tubes may have a smaller inner diameter. At least two capillary tubes of the plurality of capillary tubes may have different inner diameters, and the plurality of capillary tubes may be formed such that a capillary tube having a smaller inner diameter has a lower height from the oil level than a capillary tube having a larger inner diameter.

The plurality of capillary tubes may be disposed in a horizontal or vertical direction with respect to an oil level of the oil. The plurality of capillary tubes may be connected to the terminal at a specific or predetermined height.

The plurality of capillary tubes may be detachably attached to the terminal. The plurality of capillary tubes may be connected to the terminal at a same height from a bottom surface of the casing. The terminal may be inserted into the inner space by penetrating through a coupling groove formed on the one surface of the casing. The terminal may be formed in a shape that matches the coupling groove so as to allow the inner space to be hermetically sealed when coupled to the one surface of the casing. The terminal may be configured such that a portion thereof protruding to the inner space is connected to the plurality of capillary tubes and a portion thereof exposed to an outside of the casing is connected to the regulating unit when coupled to the one surface of the casing, so as to allow the plurality of capillary tubes and the regulating unit to be connected to each other.

The regulating unit may include a pump configured to adjust the pressure of the plurality of capillary tubes, and a valve configured to control flow paths that connect the pump and the respective capillary tubes. The valve may selectively control the flow paths connecting the pump and the respective capillary tubes.

The detection unit may control the pressure adjustment by controlling operation of the regulating unit. The detection unit may include a measuring part that measures the pressure of the plurality of capillary tubes. The detection unit may detect the condition of the oil by analyzing results of the pressure measurement of the plurality of capillary tubes. The detection unit may detect at least one of density, an oil level, and surface tension of the oil by analyzing results of the pressure measurement of the plurality of capillary tubes.

According to another embodiment disclosed herein, a compressor includes a casing having a hermetically sealed inner space, an oil storage part or storage provided at an inner space of the casing to accommodate oil therein, and an oil detecting device or detector that detects a condition of the oil accommodated in the oil storage part. Embodiments disclosed herein may include one or more of the following features. For example, the oil detecting device may include a sensing unit or sensor having a plurality of capillary tubes disposed at the inner space of the casing to be in contact with the oil, a regulating unit or regulator connected to each of the plurality of capillary tubes to adjust a pressure of the plurality of capillary tubes so that the oil is introduced into the plurality of capillary tubes, and a detection unit or detector electrically connected to the sensing unit and the regulating unit to measure the pressure of the plurality of capillary tubes, adjusted by the regulating unit, so as to detect the condition of the oil based on results of the pressure measurement.

According to another embodiment disclosed herein, a compressor includes a casing having a hermetically sealed inner space, an oil storage part or storage provided at an inner space of the casing to accommodate oil therein, and an oil detecting device or detector that detects a condition of the oil accommodated in the oil storage part. Embodiments disclosed herein may include one or more of the following features. For example, the oil detecting device may include a plurality of capillary tubes horizontally disposed at the inner space of the casing of the compressor in which a specific or predetermined amount of oil is accommodated to be in contact with the oil, a terminal insertedly coupled to one surface of the casing in a manner of penetrating through the one surface of the casing so as to be connected to the plurality of capillary tubes at the inner space, a regulating unit or regulator connected to each of the plurality of capillary tubes through the terminal to adjust pressure of the plurality of capillary tubes so that the oil is introduced into the plurality of capillary tubes, and a detection unit or detector electrically connected to the plurality of capillary tubes and the regulating unit through the terminal to measure the pressure of the plurality of capillary tubes, adjusted by the regulating unit, so as to detect the condition of the oil based on results of the pressure measurement.

In an oil detecting device and a compressor including an oil detecting device according to embodiments disclosed herein, as the condition (or state) of oil is detected using a plurality of capillary tubes, an oil level may be detected in real time, and physical properties of the oil may be detected by determining the condition of the oil in various aspects. More specifically, as the plurality of capillary tubes is provided in an inner space of a casing in which oil is received, the condition of the oil may be detected based on results of the pressure measurement of the plurality of capillary tubes, thereby determining the oil level through real-time pressure measurement of the plurality of capillary tubes and detecting physical properties of the oil by determining the condition of the oil in various aspects.

Also, in the oil detecting device and the compressor including an oil detecting device according to embodiments disclosed herein, as the plurality of capillary tubes is provided in the inner space of the casing in which oil is accommodated, the condition of the oil may be detected based on results of the pressure measurement of the plurality of capillary tubes, thereby addressing structural/design constraints or limitations in oil detection. In addition, in the oil detecting device and the compressor including an oil detecting device according to embodiments disclosed herein, as the plurality of capillary tubes is located in a horizontal direction at the inner space of the casing of the compressor in which a specific or predetermined amount of oil is accommodated so as to be in contact with the oil, thereby detecting physical properties of the oil. Thus, an element that can properly and correctly detect an oil level in real time may be provided.

That is, the oil detecting device and the compressor including an oil detecting device according to embodiments disclosed herein may reduce or address limitations of the related art. In addition, efficiency and utility in detecting the condition of the oil may be increased while increasing convenience and ease of use. Further, the oil detecting device and the compressor including an oil detecting device according to embodiments disclosed herein may address structural/design limitations of the related art.

### BRIEF DESCRIPTION OF THE DRAWINGS

FIG. 1 is a block diagram of a compressor having an oil detecting device according an embodiment;

FIG. 2 is a block diagram of an oil detecting device for a compressor according an embodiment;

FIG. 3 is an exemplary view of a compressor including an oil detecting device according an embodiment;

FIG. 4 is an exemplary view of a capillary tube according to an embodiment;

FIGS. 5A to 5D are exemplary views illustrating an example shape of a plurality of capillary tubes according to an embodiment;

FIGS. 6A and 6B are exemplary views illustrating placement of a plurality of capillary tubes according to an embodiment;

FIGS. 7A and 7B are exemplary views illustrating a micropump according to an embodiment;

FIG. 8A is an exemplary view of a compressor including an oil detecting device according to another embodiment;

FIG. 8B is an exemplary view illustrating an enlarged portion P in FIG. 8A;

FIG. 8C is another exemplary view illustrating the enlarged portion P in FIG. 8A;

FIGS. 9A and 9B are exemplary views illustrating an example shape of a plurality of capillary tubes according to another embodiment;

FIGS. 10A and 10B are exemplary views illustrating placement of a plurality of capillary tubes according to another embodiment; and

FIGS. 11A to 11C are conceptual views illustrating a principle of detecting a condition of the oil according to an embodiment.

### DETAILED DESCRIPTION

Hereinafter, an oil detecting (or detection) device for a compressor according to an embodiment will be described with reference to the accompanying drawings. Wherever possible, the same or like reference numerals have been used to indicate the same or like elements, and repetitive disclosure has been omitted.

An oil detecting device (hereinafter, “detecting device”) of a compressor according to an embodiment refers to a device that detects oil accommodated or received in the compressor. The compressor may be a hermetic compressor. The compressor may be a reciprocating, rotary, scroll, or vane type compressor, for example.

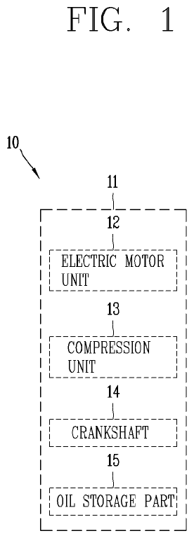

One example of the compressor in which oil, detected by the detecting device, is received is illustrated in FIG. 1. In compressor 10, as illustrated in FIG. 1, an electric motor unit or motor 12 that generates a rotational force may be installed at an inner space of a casing 11, and a compression unit 13 that compresses a refrigerant may be installed above the electric motor unit 12. The electric motor unit 12 and the compression unit 13 may be coupled by a crankshaft 14 so that a rotational force of the electric motor unit 12 is transmitted to the compression unit 13, allowing the compression unit 13 to be driven. The casing 11 may be formed in a cylindrical shape with both upper and lower ends open, and an oil storage part or portion 15 in which oil is stored may be provided at a lower space of the casing 11. For the compressor 10 having such a configuration, the detecting device may detect oil stored in the oil storage portion 15 provided at a lower portion of the inner space of the casing 11.

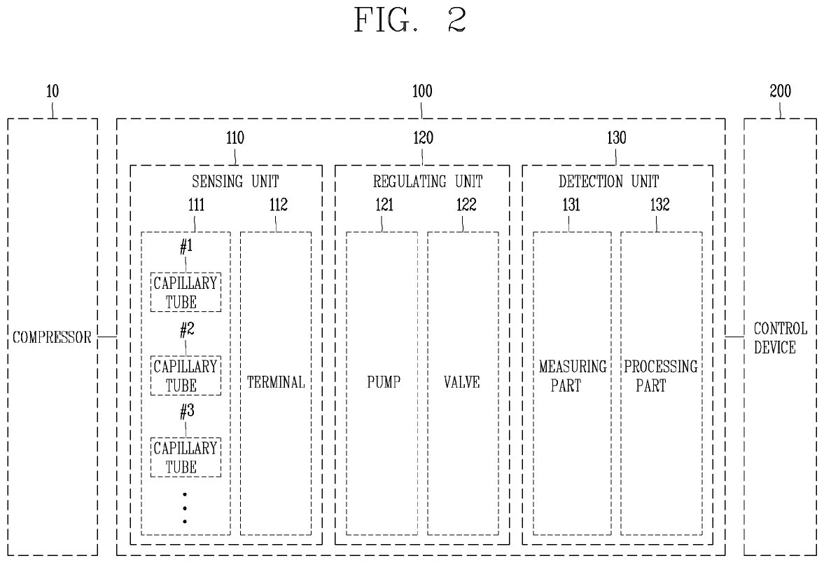

As illustrated in FIG. 2, a detecting device 100 includes a sensing unit or sensor 110 having a plurality of capillary tubes 111 located at the inner space of the casing 11 of the compressor 10 in which a predetermined amount of oil is received so as to be in contact with the oil, a regulating unit or regulator 120 that is connected to each of the plurality of capillary tubes 111 and controls pressure of the plurality of capillary tubes 111 so as to allow the oil to be introduced into the plurality of capillary tubes 111, and a detection unit or detector 130 electrically connected to the sensing unit 110 and the regulating unit 120 to measure the pressure of the plurality of capillary tubes 111, which is adjusted by the regulating unit 120, so as to detect a condition (or state) of the oil based on results of the pressure measurement. That is, the detecting device 100 equipped with the sensing unit 110, the regulating unit 120, and the detection unit 130 detects the condition of the oil accommodated in the inner space of the casing 11. Reference numeral 200 is a control device or controller.

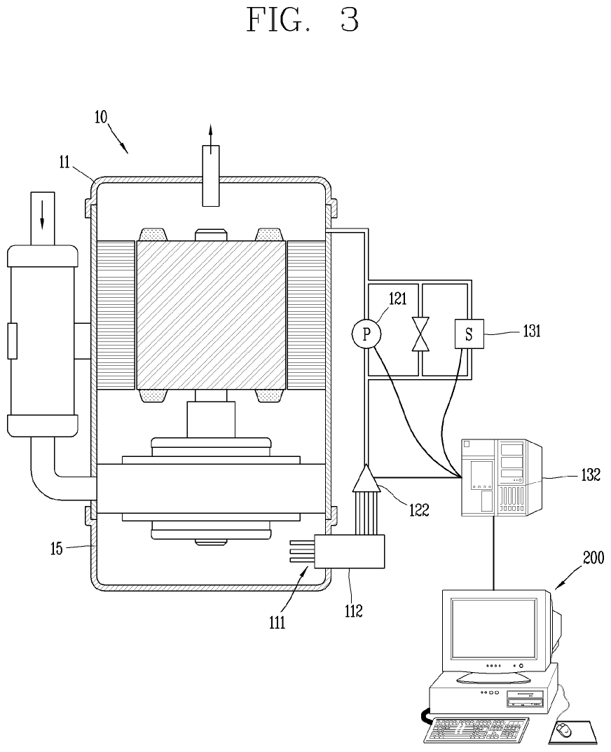

An embodiment in which the condition of oil accommodated in the inner space of the casing 11 is detected by the detecting device 100 is illustrated in FIG. 3.

In the detecting device 100, as illustrated in FIGS. 2 and 3, the sensing unit 110 is provided with the plurality of capillary tubes 111 located at the inner space of the casing 11 to be in contact with the oil, enabling the condition of the oil to be sensed. That is, as the plurality of capillary tubes 111 is located at the inner space of the casing 11 to be in contact with the oil, the sensing unit 110 may sense the condition of the oil.

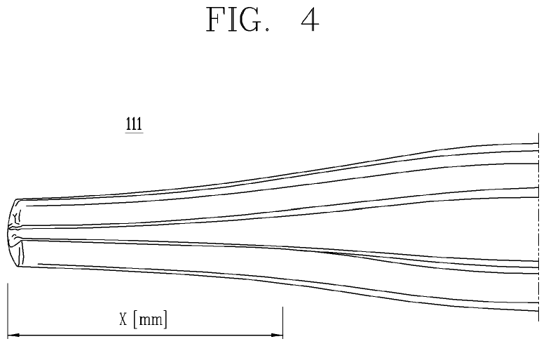

As illustrated in FIG. 4, the plurality of capillary tubes 111 may each be a sensing element in the form of a capillary tube that is in contact with a fluid to be sensed (or sensing target), so as to be partially immersed in the fluid. The plurality of capillary tubes 111 may each be a sensing element that senses a condition of fluid based on changes in pressure in a tube in contact with the fluid.

The plurality of capillary tube 111 may each have an inlet with a predetermined length (x [mm]), and the inlet may be brought into contact with the fluid. The inlet may have a size that prevents the contacted fluid from being introduced therein, due to a pressure difference.

The plurality of capillary tubes 111 may be produced by heating a glass tube. Alternatively, the plurality of capillary tubes 111 may be formed by laser processing. As the plurality of capillary tubes 111 may be made by a heating or laser processing method, the plurality of capillary tubes 111 may be easily manufactured in the form of a module.

The plurality of capillary tubes 111 may be configured to be in contact with the oil received in the inner space of the casing 11. The plurality of capillary tubes 111 may be spaced apart from one another at a specific or predetermined interval so as to be in contact with the oil in the inner space of the casing 11. Three or more of the plurality of capillary tubes 111 may be provided.

Each of the plurality of capillary tubes 111 may be formed in any one of a plurality of shapes. For example, when two capillary tubes are provided for the plurality of capillary tubes 111, one may be formed in a first shape, and the other may also be formed in the first shape so as to have the same shape, or the other may be formed in a second shape so as to have different shapes. When three capillary tubes are provided for the plurality of capillary tubes 111, one may be formed in a first shape, another may be formed in a second shape, and the last (or remaining) one may be formed in a third shape so as to have different shapes. Or, the three capillary tubes may all be formed in the first shape so as to have the same shape.

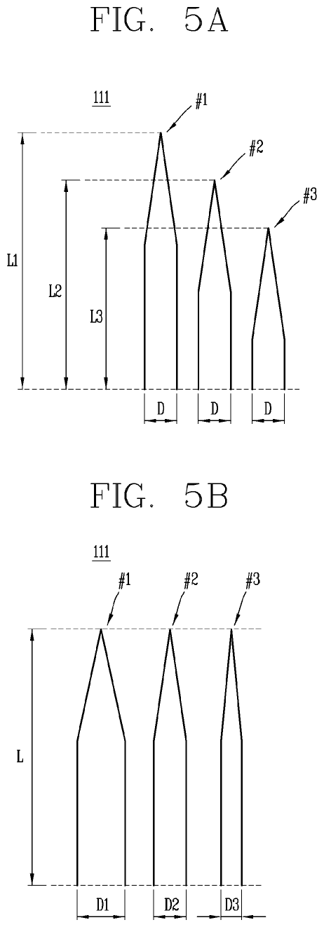

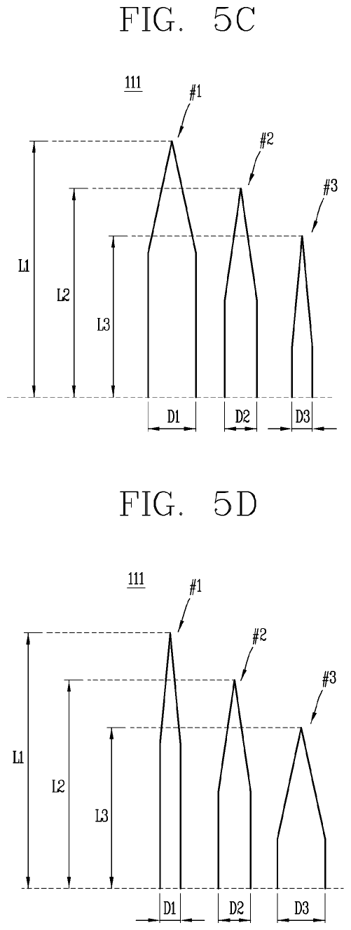

The plurality of capillary tubes 111 may have different shapes from one another. The plurality of capillary tubes 111 respectively formed in any one of the plurality of shapes may have different sizes or specifications when formed in different shapes from one another. The specification may be a specification for at least one of a length of the plurality of capillary tubes 111, a width of the plurality of capillary tubes 111, a diameter of an inlet, and a shape of the inlet. Examples of the plurality of capillary tubes 111 formed in different sizes and shapes from one another are illustrated in FIGS. 5A to 5D.

As illustrated in FIG. 5A, the plurality of capillary tubes 111 may be formed in different lengths to have different shapes. The plurality of capillary tubes 111 may be configured as a first capillary tube #1 having a first length L1, a second capillary tube #2 having a second length L2, and a third capillary tube #3 having a third length L3.

Alternatively, the plurality of capillary tubes 111 may be formed in different widths to have different shapes as illustrated in FIG. 5B. The plurality of capillary tubes 111 may be configured as a first capillary tube #1 having a first width D1, a second capillary tube #2 having a second width D2, and a third capillary tube #3 having a third width D3.

Alternatively, the plurality of capillary tubes 111 may be formed in different lengths and widths to have different shapes, as illustrated in FIGS. 5C and 5D. The plurality of capillary tubes 111 may be configured as a first capillary tube #1 having a first length L1 and a first width D1, a second capillary tube #2 having a second length L2 and a second width D2, and a third capillary tube #3 having a third length L3 and a third width D3.

When three capillary tubes 111 are formed in different shapes, two capillary tubes may have a same diameter, and any one of the two capillary tubes may have a same length (having the same length so that a distance from an oil level is the same) as the last (or remaining) capillary tube that has a different diameter.

For example, the three capillary tubes 111 may be configured such that a first capillary tube #1 and a second capillary tube #2 have the same diameter, and a third capillary tube #3 has a smaller diameter than the first capillary tube #1 and the second capillary tube #2. Also, the second capillary tube #2 and the third capillary tube #3 may have the same length so that a distance from an oil level is the same, and the first capillary tube #1 has a different length from the second capillary tube #2 and the third capillary tube #3. As such, when the plurality of capillary tubes 111 is formed in different shapes, internal pressure may vary from one capillary tube to another as the plurality of capillary tubes 111 has different sizes. Accordingly, results of the measurement may vary.

When an amount of oil introduced into the plurality of capillary tubes 111 is different, factors of the measurement results vary, which are the basis for detecting the condition of the oil, allowing the condition of the oil to be accurately detected. Further, various conditions (or properties) of the oil may be detected.

The plurality of capillary tubes 111 that has shapes and is in contact with the oil may be located at the inner space of the casing 11 to be parallel or perpendicular to a bottom surface of the casing 11. That is, as the plurality of capillary tubes 111 is located at the inner space of the casing 11 to be horizontal or perpendicular with respect to a surface of the oil accommodated in the casing 11, so as to be in contact with the oil.

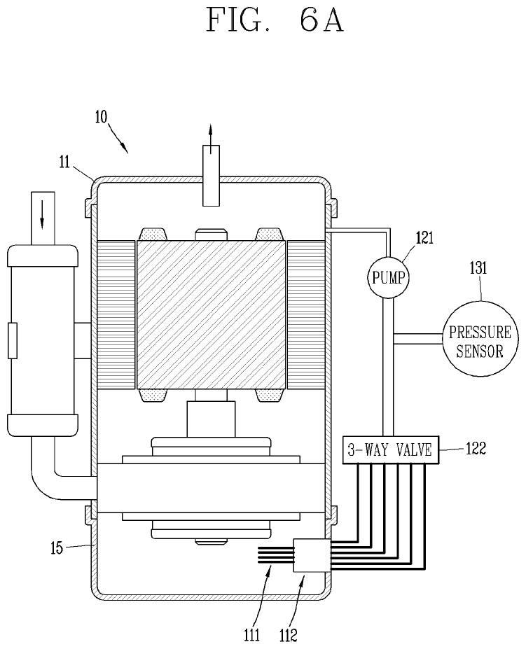

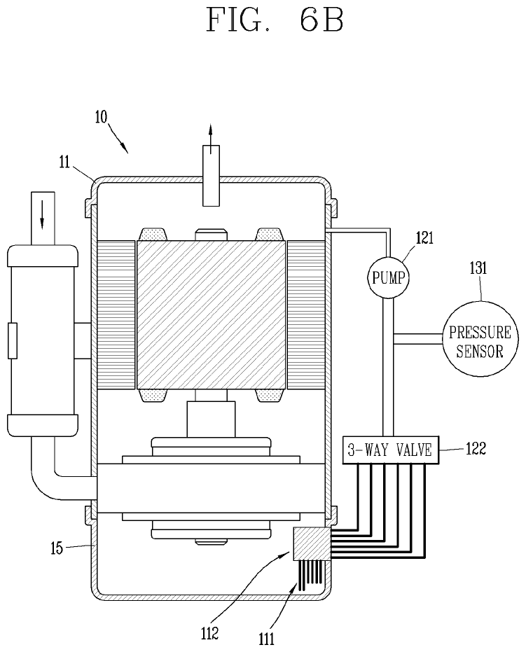

For example, the plurality of capillary tubes 111 may be located at the inner space of the casing 11 to be parallel to the bottom surface of the casing 11, as illustrated in FIG. 6A. Alternatively, the plurality of capillary tubes 111 may be provided at the inner space of the casing 11 to be perpendicular to the bottom surface of the casing 11, as illustrated in FIG. 6B. As the plurality of capillary tubes 111 is located at the inner space of the casing 11 to be parallel or perpendicular to the bottom surface of the casing 11, installation of the plurality of capillary tubes 111 for detecting the condition of the oil may be simpler and easier, or a configuration and design for detecting the condition of the oil may be simpler.

The sensing unit 110 including the plurality of capillary tubes 111 may further include a terminal 112 coupled to one surface of the casing 11 so as to be connected to the plurality of capillary tubes 111 and the regulating unit 120. The terminal 112 may connect the plurality of capillary tubes 111 and the regulating unit 120 at the inside and outside of the casing 11. The terminal 112 may include a plurality of terminal pins or a plurality of contact terminals that provides electrical connection between the plurality of capillary tubes 111 and the regulating unit 120, so as to allow the plurality of capillary tubes 111 and the regulating unit 120 to be connected thereto.

The terminal 112 may be fixedly inserted into one surface of the casing 11 via a through-hole formed on the one surface of the casing 11 at which the oil storage portion 15 is located. As the terminal 112 is fixedly inserted into the one surface of the casing 11, a portion thereof may protrude to the inner space of the casing 11 in which the oil received, and another portion thereof may protrude to the outside of the casing 11. As the terminal 112 is fixedly inserted into the one surface of the casing 11, the plurality of capillary tubes 111 may be connected to the terminal 112 at the inner space of the casing 11, and the regulating unit 120 may be connected to the terminal 112 outside of the casing 11.

The plurality of capillary tubes 111 may be detachably connected to the terminal 112. That is, the plurality of capillary tubes 111 may be configured to be attachable and detachable to and from the terminal 112. As the plurality of capillary tubes 111 is detachably coupled to the terminal 112, the plurality of capillary tubes 111 may be easily replaced.

In the detecting device 100, the regulating unit 120 may be connected to each of the plurality of capillary tubes 111, so as to control a pressure of the plurality of capillary tubes 111 in contact with the oil by adjusting the pressure of the plurality of capillary tubes 111. That is, the regulating unit 120 may be connected to each of the plurality of capillary tubes 111 to adjust the pressure of the plurality of capillary tubes 111, so as to allow the pressure of the plurality of capillary tubes 111 in contact with the oil to be measured.

The regulating unit 120 may adjust the pressure such that pressure of the plurality of capillary tubes 111 is higher than a pressure of the inner space of the casing 11. The regulating unit 120 may adjust the pressure such that pressure of the plurality of capillary tubes 111 is sequentially increased.

As illustrated in FIGS. 2 and 3, the regulating unit 120 may include a pump 121 that controls the pressure of the plurality of capillary tubes 111 and a valve 122 that regulates or controls a flow path connecting the pump 121 and the sensing unit 110.

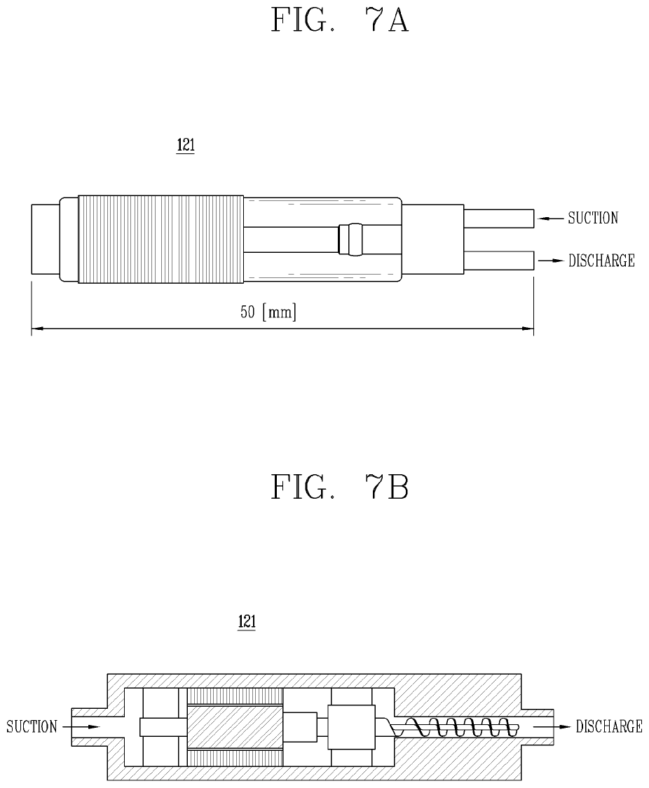

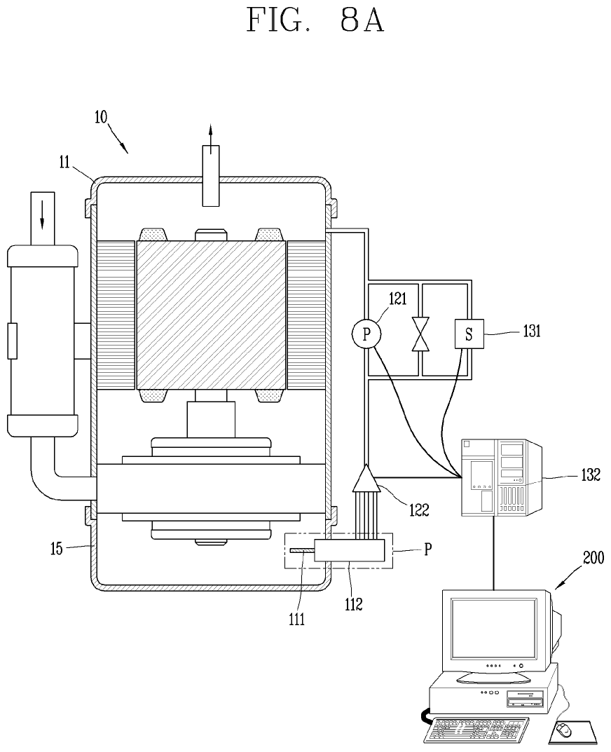

The pump 121 may be a micropump connected to each of the plurality of capillary tubes 111 to control the pressure of each of the plurality of capillary tubes 111, and thereby to allow the oil to be introduced therein. The pump 121 configured as the micropump may be a micro linear pump having a suction port and a discharge port formed in a same direction, as illustrated in FIG. 7A, or a micro screw pump having a suction port and a discharge port formed in different (opposite) directions, as illustrated in FIG. 7B.

When the pump 121 is configured as the linear pump, one output (bubble) per stroke may be achieved, allowing pressure of the plurality of capillary tubes 111 to be individually adjusted. When the pump 121 is configured as the screw pump, a tiny amount of oil may be continuously supplied, and it may be more suitable for the manufacture of the pump as a hermetic type. For example, the pump 121 may be configured as a linear pump of 50 [mm], which is a small-sized pump with one output (bubble) per stroke, so as to individually control the pressure of the plurality of capillary tubes 111.

The pump 121 may be controlled by the detection unit 130, which allows the pressure of the plurality of capillary tubes 111 to be adjusted. For example, the pump 121 receives a control signal for controlling the pressure of the plurality of capillary tubes 111 from the detection unit 130, so as to adjust the pressure of the plurality of capillary tubes 111 according to the control signal.

The detection unit 130 may determine a target pressure value of the plurality of capillary tubes 111 according to each pressure of the plurality of capillary tubes 111, generate a control signal according to the determined target pressure value, and then transfer the control signal to the pump 121. This may allow the pump 121 to adjust the pressure of the plurality of capillary tubes 111 according to the target pressure value.

The valve 122 may be a valve that opens and closes a flow path connecting the sensing unit 110 and the pump 121 by being located therebetween. The valve 122 may be a multi-path (or multi-channel) valve that is connected to flow paths connecting the pump 121 and each capillary tube 111, so as to selectively control the flow paths connecting the pump 121 and the respective capillary tubes 111. For example, in a case in which three capillary tubes 111 are provided, the valve 122 may be a 3-way valve that selectively controls three flow paths connecting the pump 121 and each capillary tube 111.

The valve 122 may be controlled by the detection unit 130 so as to selectively control the flow paths connecting the pump 121 and the respective capillary tubes 111. For example, the valve 122 may receive a control signal for opening and closing the flow paths from the detection unit 130, so as to selectively open and close the flow paths according to the control signal.

The detection unit 130 may determine a capillary tube to be opened or closed among the plurality of capillary tubes 111, generate a control signal according to the determined capillary tube to be opened or closed, and then transmit the control signal to the valve 122. Accordingly, the valve 122 may select a flow path connected to the corresponding capillary tube to open or close.

In the detecting device 100, as the detection unit 130 is electrically connected to the sensing unit 110 and the regulating unit 120, the detection unit 130 may measure the pressure of the plurality of capillary tubes 111, which is adjusted by the regulating unit 120, detect the condition of the oil based on results of the measurement, and then control pressure adjustment of the plurality of capillary tubes 111 through the regulating unit 120, so as to detect the condition of the oil. That is, after the pressure is adjusted by regulating unit 120, the detection unit 130 may detect the condition of the oil based on results of the measurement of the adjusted pressure of the plurality of capillary tubes 111.

The detection unit 130 may control the pressure adjustment by controlling operation of the regulating unit 120. That is, the detection unit 130 may control the pressure adjustment of the regulating unit 120 to detect the condition of the oil, and analyze results of the measurement of the adjusted pressure to detect the condition of the oil.

As illustrated in FIGS. 2 and 3, the detection unit 130 may include a measuring part or portion 131 configured to measure the pressure of the plurality of capillary tubes 111. The measuring portion 131 may be a pressure sensor that measures the pressure of the plurality of capillary tubes 111.

The measuring portion 131 may measure the pressure of each of the plurality of capillary tubes 111, which is adjusted by the regulating unit 120. That is, the measuring portion 131 may measure changes in pressure of the plurality of capillary tubes 111. As the measuring portion 131 measures the pressure of each of the plurality of capillary tubes 111, the detection unit 130 may detect the condition of the oil based on results of the pressure measurement.

The detection unit 130 including the measuring part 131 may further include a processing part or portion or processor 132, as illustrated in FIGS. 2 and 3. The processing portion 132 may control the pressure adjustment by controlling operation of the regulating unit 120, and detect the condition of the oil by analyzing results of the pressure measurement.

The processing portion 132 may control operation of the regulating unit 120 by generating and transmitting a control signal for controlling the pressure adjustment to the regulating unit 120, and detect the condition of the oil by analyzing results of the pressure measurement received from the measuring portion 131.

That is, as the measuring portion 131 measures the pressure of each of the plurality of capillary tubes 111, and the processing portion 132 controls the operation of the regulating unit 120, the detection unit 130 may detect the condition of the coil by analyzing results of the measurement by the measuring portion 131.

In this case, the measuring portion 131 may measure pressure of each of the plurality of capillary tubes 111 to transmit respective results of the measurement to the processing portion 132. Then, the processing portion 132 may generate a control signal for the pump 121 and the valve 122 and transmit the respective control signals to the pump 121 and the valve 122, so as to individually control the pump 121 and the valve 122, thereby allowing pressure adjustment of the plurality of capillary tubes 111 to be controlled.

The processing portion 132 may be in communication with the compressor 10 or the detecting device 100, so as to communicate with an external control device or controller 200 that controls the compressor 10 or the detecting device 100. The control device 200 may be a device that controls or monitors the compressor 10 or the detecting device 100 by communicating with the compressor 10 or the detecting device 100 at the outside of the compressor 10 or the detecting device 100.

The control device 200 may be a higher (higher-level) control element of the detecting device 100. The control device 200 may control such that the pressure adjustment is performed by transmitting a command for generation of the control signal to the detecting device 100, or may determine and detect the condition of the oil by receiving results of the pressure measurement from the detecting device 100.

The detection unit 130 may detect the condition of the oil in real time. The detection unit 130 may determine and detect changes in the condition of the oil through the respective capillary tubes 111, allowing the condition of the oil to be detected in real time.

The detection unit 130 may detect the condition of the oil by analyzing respective results of the pressure measurement of the plurality of capillary tubes 111. That is, the detection unit 130 may analyze results of the pressure measurement to determine the condition of the oil, and thereby to detect the condition of the oil.

The detection unit 130 may analyze results of the pressure measurement to detect at least one of density, an oil level, or surface tension of the oil. That is, the detection unit 130 may detect at least one of the density, oil level, or surface tension of the oil based on results of the pressure measurement.

For example, as the detection unit 130 compares numerical values of the measurement results of the plurality of capillary tubes 111, or calculates by combining them, a numerical value for at least one of density, an oil level, and surface tension of the oil is calculated, thereby detecting at least one of the density, oil level, and surface tension of the oil.

Hereinafter, an oil detecting device for a compressor according to another embodiment will be described with reference to the accompanying drawings.

The detecting device 100 includes, as described in FIG. 2, the plurality of capillary tubes 111 horizontally disposed at an inner space of the casing 11 of the compressor 10 in which a predetermined or specific amount of oil is received so as to be in contact with the oil, the terminal 112 that is inserted into one surface of the casing 11 in a manner of penetrating through the one surface of the casing 11 so as to be connected to the plurality of capillary tubes 111 at the inner space, the regulating unit 120 that is connected to the plurality of capillary tubes 111 through the terminal 112 and controls the pressure of the plurality of capillary tubes 111 so as to allow the oil to be introduced into the plurality of capillary tubes 111, and the detection unit 130 that is electrically connected to the plurality of capillary tubes 111 and the regulating unit 120 through the terminal 112 to measure the pressure of the plurality of capillary tubes 111, which is adjusted by the regulating unit 120, so as to detect the condition of the oil based on results of the pressure measurement. The plurality of capillary tubes 111 and the terminal 112 may define the sensing unit 110 as the plurality of capillary tubes 111 is connected to the terminal 112 at the inner space. That is, as the detecting device 100 is provided with the sensing unit 110, the regulating unit 120, and the detection unit 130, the condition of the oil accommodated in the inner space of the casing 11 may be detected.

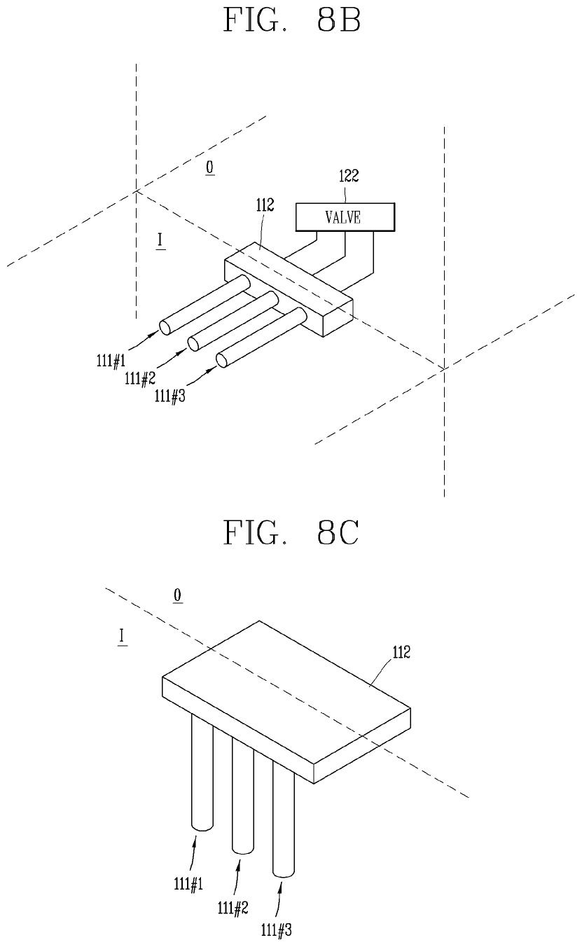

An embodiment in which the condition of oil accommodated in the inner space of the casing 11 is detected by the detecting device 100 is illustrated in FIG. 8A.

In the detecting device 100, the sensing unit 110 including the plurality of capillary tubes 111 and the terminal 112 may be configured such that the plurality of capillary tubes 111 horizontally disposed at the inner space of the casing 11 to be in contact with the oil is connected to the terminal 112 at the inner space, so as to allow the condition of the oil to be sensed, as illustrated in FIG. 8A. That is, as the plurality of capillary tubes 111 is brought into contact with the oil by being located at the inner space of the casing 11, the sensing unit 110 may sense the condition of the oil through the plurality of capillary tubes 111.

The plurality of capillary tubes 111 may be connected to the terminal 112 that is insertedly coupled to one surface of the casing 11 in a manner of perennating through the one surface of the casing 11. The plurality of capillary tubes 111 may be connected to the terminal 112 as illustrated in FIG. 8B or FIG. 8C.

FIGS. 8B and 8C are exemplary views of an enlarged portion P of FIG. 8A, illustrating one surface of the casing 11 to which the plurality of capillary tubes 111 and the terminal 112 are connected and the portion P of the inner space. However, the plurality of capillary tubes 111 and the terminal 112 may be connected in different manners other than the examples illustrated in FIGS. 8B and 8C.

As illustrated in 8B, the plurality of capillary tubes 111 may be disposed in a horizontal direction with respect to a bottom surface of the casing 11 and disposed to be perpendicular to one surface of the casing 11, so as to be connected to the terminal 112, which is inserted into the inner space I from outside O of the casing 11 in a manner of penetrating through the one surface of the casing 11, at the inner space I. As the plurality of capillary tubes 111 is connected to the terminal 112 by being disposed in the horizontal direction with respect to the bottom surface and disposed to be perpendicular to the one surface of the casing 11, the plurality of capillary tubes 111 may be in contact with the oil to be horizontal with respect to an oil level of the oil. That is, when the plurality of capillary tubes 111 is arranged in the horizontal direction with respect to the oil level of the oil, as illustrated in FIG. 8B, the plurality of capillary tubes 111 may be brought into contact with the oil in the horizontal direction to be in contact with the oil at a specific height.

Alternatively, as illustrated in FIG. 8C, the plurality of capillary tubes 111 may be disposed in a vertical direction with respect to the bottom surface the casing 11 to be perpendicular to the bottom surface, and disposed to be parallel to one surface of the casing 11 so as to be connected to the terminal 112, which is inserted into the inner space I from outside O of the casing 11 in a manner of penetrating through the one surface of the casing 11, at the inner space I. As the plurality of capillary tubes 111 is connected to the terminal 112 by being disposed to be parallel to the bottom surface and disposed to be parallel to the one surface of the casing 11, the plurality of capillary tubes 111 may be in contact the oil to be perpendicular to an oil level of the oil. That is, when the plurality of capillary tubes 111 is arranged in the vertical direction with respect to the oil level of the oil, as illustrated in FIG. 8C, the plurality of capillary tubes 111 may be brought into contact with the oil in the vertical direction so as to be in contact with the oil at different heights.

As the plurality of capillary tubes 111 is disposed to be parallel to the bottom surface of the inner space so as to be connected to the terminal 112, as illustrated in FIGS. 8B and 8C, the plurality of capillary tubes 111 may be provided at the inner space while occupying a minimum area. In addition, pressure adjustment and measurement of the pressure of the plurality of capillary tubes 111 in contact with the oil may be accurately performed, while the plurality of capillary tubes 111 is provided in the inner space by occupying the minimum area.

As illustrated in FIG. 4, the plurality of capillary tubes 111 may be a sensing element in the form of a capillary tube that is in contact with a fluid to be sensed (or sensing target), so as to be partially immersed in the fluid. The plurality of capillary tubes 111 may be a sensing element that senses the condition of fluid based on changes in pressure in a tube in contact with the fluid. The plurality of capillary tubes 111 may each have an inlet with a predetermined length (x [mm]), and the inlet may be brought into contact with the fluid. The inlet may have a size that prevents the contacted fluid from being introduced therein, due to a pressure difference.

The plurality of capillary tubes 111 may be produced by heating a glass tube. Alternatively, the plurality of capillary tubes 111 may be formed by laser processing. As the plurality of capillary tubes 111 may be made by a heating or laser processing method, the plurality of capillary tubes 111 may be easily manufactured in the form of a module.

The plurality of capillary tubes 111 may be configured to be in contact with the oil received in the inner space of the casing 11. The plurality of capillary tubes 111 may be spaced apart from one another at a specific or predetermined interval so as to be in contact with the oil in the inner space of the casing 11.

The plurality of capillary tubes 111 may be three or more in number. Each of the plurality of capillary tubes 111 may be formed in any one of a plurality of shapes.

For example, when two capillary tubes are provided for the plurality of capillary tubes 111, one may be formed in a first shape, and the other may also be formed in the first shape so as to have the same shape, or the other may be formed in a second shape so as to have different shapes. When three capillary tubes are provided for the plurality of capillary tubes 111, one may be formed in a first shape, another may be formed in a second shape, and the last (or remaining) one may be formed in a third shape so as to have different shapes. Alternatively, the three capillary tubes may be all formed in the first shape so as to have the same shape.

The plurality of capillary tubes 111 may have different shapes from one another. The plurality of capillary tubes 111 respectively formed in any one of the plurality of shapes may have different sizes or specifications when formed in different shapes from one another. The specification may be a specification for at least one of a length of the plurality of capillary tubes 111, a width of the plurality of capillary tubes 111, a diameter of an inlet, and a shape of the inlet.

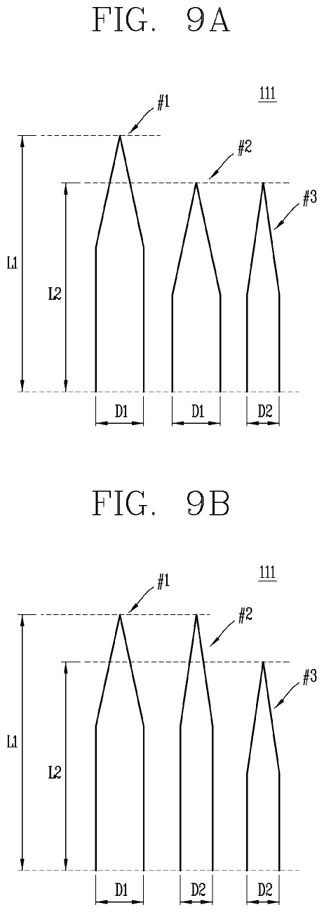

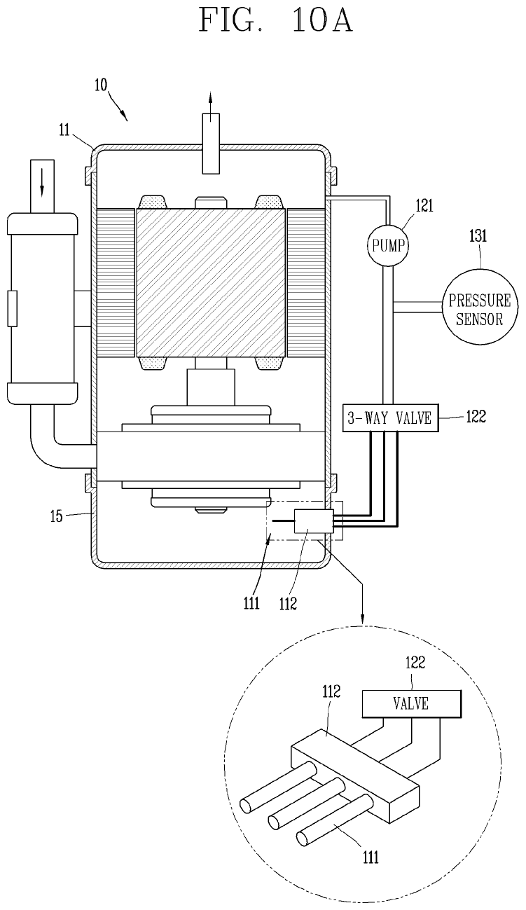

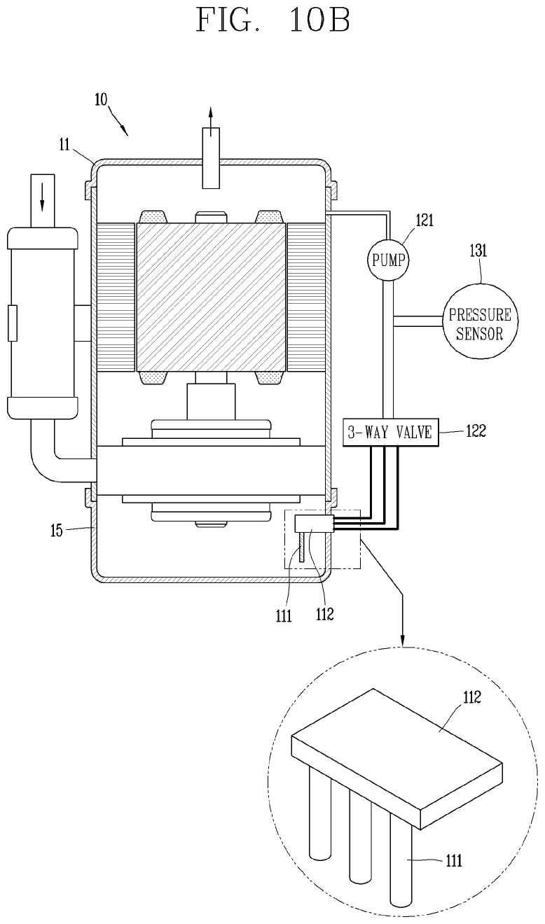

Examples of the plurality of capillary tubes 111 formed in different sizes and shapes from one another are illustrated in FIGS. 9A and 9B.

As illustrated in FIG. 9A, the plurality of capillary tubes 111 may be formed in different shapes. The plurality of capillary tubes 111 may be configured as a first capillary tube #1 having a first length L1 and a first width D1, a second capillary tube #2 having a second length L2 and the first width D1, and a third capillary tube #3 having the second length L2 and a second width D2. Alternatively, the plurality of capillary tubes 111 may be formed in different shapes, as illustrated in FIG. 9B. The plurality of capillary tubes 111 may be configured as a first capillary tube #1 having a first length L1 and a first width D1, a second capillary tube #2 having the first length L1 and a second width D2, and a third capillary tube #3 having a second length L2 and the second width D2.

Alternatively, the plurality of capillary tubes 111 may be formed in different lengths and widths to have different shapes, as illustrated in FIGS. 5C and 5D. For example, the plurality of capillary tubes 111 may be configured as a first capillary tube #1 having a first length L1 and a first width D1, a second capillary tube #2 having a second length L2 and a second width D2, and a third capillary tube #3 having a third length L3 and a third width D3.

When three capillary tubes 111 are formed in different shapes, two capillary tubes may have the same diameter, and any one of the two capillary tubes may have the same length (having the same length so that a distance from an oil level is the same) as the last capillary tube that has a different diameter. For example, as illustrated in FIG. 9A, the first capillary tube #1 and the second capillary tube #2 may have the same diameter, and the third capillary tube #3 may have a smaller diameter than the first capillary tube #1 and the second capillary tube 2. Also, the second capillary tube #2 and the third capillary tube #3 may have the same length so that a distance from an oil level is the same, and the first capillary tube #1 may have a different length from the second capillary tube #2 and the third capillary tube #3.

When the plurality of capillary tubes 111 is formed in different shapes, internal pressure may vary from one capillary tube to another as the plurality of capillary tubes 111 has different sizes. Accordingly, results of the pressure measurement may vary.

When an amount of oil introduced into the plurality of capillary tubes 111 is different, factors of the measurement results vary, which are the basis for detecting the condition of the oil, allowing the condition of the oil to be accurately detected. Further, various conditions of the oil may be detected.

The plurality of capillary tubes 111 that has such shapes and is in contact with the oil may be located at the inner space of the casing 11 to be parallel or perpendicular to the bottom surface of the casing 11. That is, the plurality of capillary tubes 111 is located at the inner space of the casing 11 to be horizontal or perpendicular with respect to a surface of the oil accommodated in the casing 11, so as to be in contact with the oil.

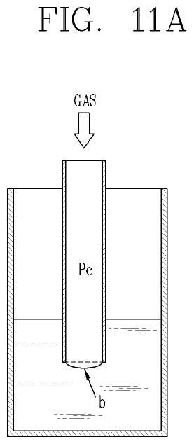

For example, the plurality of capillary tubes 111 may be provided at the inner space of the casing 11 to be parallel to the bottom surface of the casing 11, as illustrated in FIG. 10A. Alternatively, the plurality of capillary tubes 111 may be provided at the inner space of the casing 11, to be perpendicular to the bottom surface of the casing 11, as illustrated in FIG. 10B.

As the plurality of capillary tubes 111 is located at the inner space of the casing 11 to be parallel or perpendicular to the bottom surface of the casing 11, installation of the plurality of capillary tubes 111 for detecting the condition of the oil may be simpler and easier, or a configuration and design for detecting the condition of the oil may be simpler.

The plurality of capillary tubes 111 may be connected to the terminal 112 at a specific or predetermined height. The plurality of capillary tubes 111 may be configured such that a connection portion thereof may be connected to the terminal 112 at a specific or predetermined height.

Further, the plurality of capillary tubes 111 may be spaced apart from an inner wall of the casing 11 by a predetermined distance so as to be connected to the terminal 112. For example, as illustrated in FIG. 8B or 8C, three capillary tubes #1, #2, and #3 may be spaced apart from the inner wall of the casing 11 by a predetermined distance at a specific or predetermined height, so as to be connected to the terminal 112 at the specific height.

The plurality of capillary tubes 111 may be detachably connected to the terminal 112. That is, the plurality of capillary tubes 111 may be configured to be attachable and detachable to and from the terminal 112. As the plurality of capillary tubes 111 is detachably connected to the terminal 112, replacement and maintenance of the plurality of capillary tubes 111 may be easier.

The sensing unit 110 including the plurality of capillary tubes 111 may further include the terminal 112 coupled to one surface of the casing 11, so as to be connected to the plurality of capillary tubes 111 and the regulating unit 120. The terminal 112 may be a connection element that connects the plurality of capillary tubes 111 and the regulating unit 120 at the inside and outside of the casing 11.

The terminal 112 may include a plurality of terminal pins or a plurality of contact terminals that provides electrical connection between the plurality of capillary tubes 111 and the regulating unit 120, so as to allow the plurality of capillary tubes 111 and the regulating unit 120 to be connected thereto. The plurality of capillary tubes 111 may be connected to the terminal 112 at the same height from the bottom surface of the casing 11. That is, as illustrated in FIG. 8B or 8C, the plurality of capillary tubes 111 may be connected to the terminal 112 at a specific or predetermined height.

The plurality of capillary tubes 111 may be connected to a front portion of the terminal 112 protruding into the inner space, or a lower portion of the terminal 112. The plurality of capillary tubes 111 may be connected to the terminal 112 at a position at which a distance from an inner surface of the inner space is spaced apart by a predetermined distance.

The terminal 112 may be fixedly inserted into one surface of the casing 11 via a through-hole formed on the one surface of the casing 11 in which the oil storage portion 15 is located. The terminal 112 may be inserted into the inner space by penetrating through a coupling groove formed on one surface of the casing 11. The terminal 112 may be formed in a shape that matches the coupling groove so that the inner space is hermetically sealed when coupled to the one surface of the casing 11. That is, the terminal 112 may have an area less than or equal to an area of the coupling groove.

The terminal 112 may be formed in any one of a pin shape, a plate shape, or a bar shape to be inserted into the inner space through the coupling groove, so as to allow the inner space to be hermetically sealed when the terminal 112 is coupled to the one surface of the casing 11. The terminal 112 may be configured as a pin having a flat plate shape, as illustrated in FIG. 8B or 8C. That is, the coupling groove may be formed in a plate shape to which the terminal 112 configured as the plate-shaped pin may be inserted, and the terminal 112 may be configured as a pin having a plate shape that matches the coupling groove so as to be inserted into the inner space by penetrating through the coupling groove.

As the terminal 112 is inserted into the one surface of the casing 11, a part or portion thereof may protrude into the inner space of the casing 11 in which the oil is accommodated, and another portion thereof may protrude to the outside of the casing 11. As the terminal 112 is insertedly coupled to the one surface of the casing 11, the terminal 112 and the plurality of capillary tubes 111 may be connected to each other at the inner space of the casing 11, and the terminal 112 and the regulating unit 120 may be connected to each other outside of the casing 11. As the terminal 112 is insertedly coupled to the one surface of the casing 11, the portion thereof protruding into the inner space may be connected to the plurality of capillary tubes 111, and the portion thereof exposed to the outside of the casing 11 may be connected to the regulating unit 120, thereby allowing the plurality of capillary tubes 111 and the regulating unit 120 to be connected each other.

In the detecting device 100, the regulating unit 120 is connected to each of the plurality of capillary tubes 111, so as to control pressure of the plurality of capillary tubes 111 in contact with the oil by adjusting the pressure of the plurality of capillary tubes 111. That is, the regulating unit 120 is connected to each of the plurality of capillary tubes 111 to adjust the pressure of the plurality of capillary tubes 111, and thereby to allow the pressure of the plurality of capillary tubes 111 in contact with the oil to be measured.

The regulating unit 120 may adjust the pressure such that pressure of the plurality of capillary tubes 111 is higher than pressure of the inner space of the casing 11. The regulating unit 120 may adjust the pressure such that the pressure of the plurality of capillary tubes 111 is sequentially increased.

As illustrated in FIG. 2 and FIG. 8A, the regulating unit 120 may include the pump 121 that controls pressure of the plurality of capillary tubes 111 and the valve 122 that regulates or controls a flow path connecting the pump 121 and the sensing unit 110. The pump 121 may be a micropump connected to each of the plurality of capillary tubes 111 to control the pressure of each of the plurality of capillary tubes 111, and thereby to allow the oil to be introduced therein.

The pump 121 configured as the micropump may be a micro linear pump having a suction port and a discharge port formed in the same direction, as illustrated in FIG. 7A, or a micro screw pump having a suction port and a discharge port formed in different (opposite) directions, as illustrated in FIG. 7B. When the pump 121 is configured as the linear pump, one output (bubble) per stroke may be achieved, allowing pressure of the plurality of capillary tubes 111 to be individually adjusted. When the pump 121 is configured as the screw pump, a tiny amount of oil may be continuously supplied, and it may be more suitable for the manufacture of the pump as a hermetic type. For example, the pump 121 may be configured as a linear pump of 50 [mm], which is a small-sized pump with one output (bubble) per stroke, so as to individually control the pressure of the plurality of capillary tubes 111.

The pump 121 may be controlled by the detection unit 130, which allows the pressure of the plurality of capillary tubes 111 to be adjusted. For example, the pump 121 receives a control signal for controlling the pressure of the plurality of capillary tubes 111 from the detection unit 130, so as to adjust the pressure of the plurality of capillary tubes 111 according to the control signal.

In this case, the detection unit 130 may determine a target pressure value of the plurality of capillary tubes 111 according to each pressure of the plurality of capillary tubes 111, generate a control signal according to the determined target pressure value, and then transfer the control signal to the pump 121. This may allow the pump 121 to adjust the pressure of the plurality of capillary tubes 111 according to the target pressure value.

The valve 122 may be a valve that opens and closes an oil flow path connecting the sensing unit 110 and the pump 121 by being located therebetween. The valve 122 may a multi-path (or multi-channel) valve that is connected to flow paths connecting the pump 121 and each capillary tube 111, so as to selectively control the flow paths connecting the pump 121 and the respective capillary tubes 111.

For example, in the case in which three capillary tubes 111 are provided, the valve 122 may be a 3-way valve that selectively controls three flow paths connecting the pump 121 and each capillary tube 111. The valve 122 may be controlled by the detection unit 130 so as to selectively control the flow paths connecting the pump 121 and the respective capillary tubes 111.

For example, the valve 122 may receive a control signal for opening and closing the flow paths from the detection unit 130, so as to selectively open and close the flow paths according to the control signal. The detection unit 130 may determine a capillary tube to be opened or closed among the plurality of capillary tubes 111, generate a control signal according to the determined capillary tube to be opened or closed, and then transmit the control signal to the valve 122. Accordingly, the valve 122 may select a flow path connected to the corresponding capillary tube to open or close.

In the detecting device 100, as the detection unit 130 is electrically connected to the sensing unit 110 and the regulating unit 120, the detection unit 130 may measure pressure of the plurality of capillary tubes 111, which is adjusted by the regulating unit 120, detect the condition of the oil based on results of the measurement, and then control pressure adjustment of the plurality of capillary tubes 111 through the regulating unit 120, so as to detect the condition of the oil. That is, after the pressure is adjusted by regulating unit 120, the detection unit 130 may detect the condition of the oil based on results of the measurement of the adjusted pressure of the plurality of capillary tubes 111.

The detection unit 130 may control the pressure adjustment by controlling operation of the regulating unit 120. That is, the detection unit 130 may control the pressure adjustment of the regulating unit 120 to detect the condition of the oil, and analyze the measurement results of the pressure adjustment to detect the condition of the oil.

As illustrated in FIG. 2 and FIG. 8A, the detection unit 130 may include the measuring portion 131 configured to measure the pressure of the plurality of capillary tubes 111. The measuring portion 131 may be a pressure sensor that measures pressure of the plurality of capillary tubes 111.

The measuring portion 131 may measure the pressure of each of the plurality of capillary tubes 111, which is adjusted by the regulating unit 120. That is, the measuring portion 131 may measure changes in pressure of the plurality of capillary tubes 111. As the pressure of each of the plurality of capillary tubes 111 is measured by the measuring portion 131, the detection unit 130 may detect the condition of the oil based on results of the pressure measurement.

The detection unit 130 including the measuring portion 131 may further include the processing portion 132, as illustrated in FIG. 2 and FIG. 8A. The processing portion 132 may control the pressure adjustment by controlling operation of the regulating unit 120, and detect the condition of the oil by analyzing results of the pressure measurement.

The processing portion 132 may control operation of the regulating unit 120 by generating and transmitting the control signal for controlling the pressure adjustment to the adjustment unit 120, and detect the condition of the oil by analyzing results of the pressure measurement received from the measuring portion 131.

That is, as the measuring portion 131 measures the pressure of each of the plurality of capillary tubes 111, and the processing portion 132 controls the operation of the regulating unit 120, the detection unit 130 may detect the condition of the oil by analyzing results of the pressure measurement by the measuring portion 131.

In this case, the measuring portion 131 may measure pressure of each of the plurality of capillary tubes 111 to transmit respective results of the measurement to the processing portion 132. Then, the processing portion 132 may generate a control signal for the pump 121 and the valve 122 and transmit the respective control signals to the pump 121 and the valve 122, so as to individually control the pump 121 and the valve 122, thereby allowing pressure adjustment of the plurality of capillary tubes 111 to be controlled. The processing portion 132 may be in communication with the compressor 10 or the detecting device 100, so as to communicate with external control device or controller 200 that controls the compressor 10 or the detecting device 100.

The control device 200 may be a device that controls or monitors the compressor 10 or the detecting device 100 by communicating with the compressor 10 or the detecting device 100 at the outside of the compressor 10 or the detecting device 100. The control device 200 may be a higher (higher-level) control element than the detecting device 100. The control device 200 may control such that the pressure adjustment is performed by transmitting a command for generation of the control signal to the detecting device 100, or may determine and detect the condition of the oil by receiving results of the pressure measurement from the detecting device 100.

The detection unit 130 may detect the condition of the oil in real time. The detection unit 130 may determine and detect changes in the condition of the oil through the respective capillary tubes 111, allowing the condition of the oil to be detected in real time.

The detection unit 130 may detect the condition of the oil by analyzing the respective results of the pressure measurement of the plurality of capillary tubes 111. That is, the detection unit 130 may analyze results of the pressure measurement to determine the condition of the oil, and thereby to detect the condition of the oil.

The detection unit 130 may analyze results of the pressure measurement to detect at least one of density, an oil level, or surface tension of the oil. That is, the detection unit 130 may detect at least one of the density, oil level, or surface tension of the oil based on results of the pressure measurement.

For example, as the detection unit 130 compares numerical values of the pressure measurement results of the plurality of capillary tubes 111, or calculates by combining them, a numerical value for at least one of density, an oil level, or surface tension of the oil is calculated, thereby detecting at least one of the density, oil level, or surface tension of the oil.

Hereinafter, a specific principle and an example of detecting the condition of the oil through the plurality of capillary tubes 111 by the detecting device 100 will be described.

As described above, the detecting device 100 may control pressure of the plurality of capillary tubes 111 and measure the pressure of the plurality of capillary tubes 111 to detect the condition of the oil

A specific detection principle of detecting the condition of the oil by the detecting device 100 is described hereinafter.

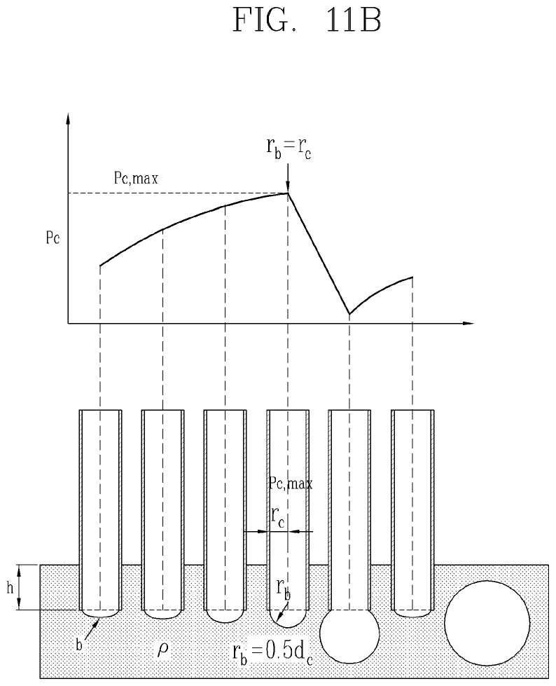

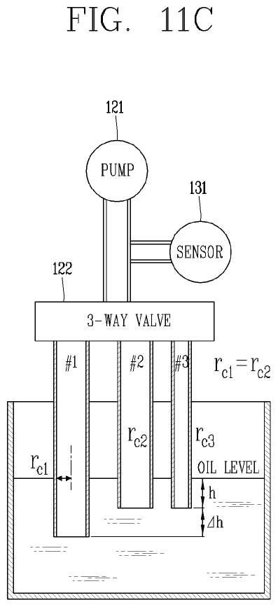

In a state in which the plurality of capillary tubes 111 is disposed to be in contact with the oil in the oil storage portion 15, that is, the plurality of capillary tubes 111 is disposed at the oil, when a pressurized or compressed gas is supplied to an end portion or end of the capillary tube that is not immersed in the oil to adjust pressure, as illustrated in FIG. 11A, a bubble b is formed at an end portion or end that is immersed in the oil. As illustrated in FIG. 11B, a size of the bubble b generated at the end portion of the capillary tube gradually increases due to pressure of the supplied gas, and the bubble b becomes a semicircle (r b) at a specific moment and its radius becomes equal to a radius (r c) of the capillary tube, that is when pressure (P C) of the capillary tube becomes a maximum internal pressure (P C max). This is, when the maximum internal pressure (P C max) of the capillary tube is balanced with surface tension of the oil, and the pressure at this time is a Max. bubble pressure (hereinafter, it is referred to as “maximum bubble pressure”). Here, a correlation between the surface tension (a) and the maximum internal pressure (P C max) may be as shown in [Equation 1] below.

$$σ = \frac{{r}_{c}}{2} \{ {P}_{c , ma x} - ρ g h \} \qquad [ Equation 1 ]$$

In the [Equation 1], “g” may denote gravitational acceleration, and “p” may denote a density of the oil.

When the pressure is adjusted by continuously supplying the gas to the capillary tube, the generated bubble b is separated from the capillary tube as the pressure inside the capillary tube rapidly decreases with increase of the generated bubble b.

As illustrated in FIG. 11C, the plurality of capillary tubes 111 may be configured as three capillary tubes #1, #2, and #3 having different shapes or sizes. For example, the first capillary tube #1 and the second capillary tube #2 may have the same diameter, and the third capillary tube #3 may have a smaller diameter than the other two capillary tubes. Based on an oil level, a height h+Δh of the first capillary tube #1 may be greater (longer) than a height h of the second capillary tube #2, and the second capillary tube #2 and the third capillary tube #3 may have the equal height h. When the maximum bubble pressure of each of the capillary tubes #1, #2, and #3 is measured under this state, density, an oil level, or surface tension of the oil may be calculated on the basis of the maximum bubble pressure of each of the capillary tubes #1, #2, and #3.

In the example illustrated in FIG. 11C, the density, oil level, and surface tension of the oil may be calculated according to [Equation 2], [Equation 3], and [Equation 4], respectively, as follows.

$$\begin{matrix}ρ = \frac{{P}_{c 1 , ma x} - {P}_{c 2 , m ax}}{Δ h \cdot g} & [ Equation 2 ] \\ h = \frac{{P}_{c 3 , m ax} {r}_{c 3} - {P}_{c 2 , ma x} {r}_{c 2}}{( {r}_{c 3} - {r}_{c 2} ) ρ g} - \frac{2 ( {r}_{c 3} - {r}_{c 2} )}{3} & [ Equation 3 ] \\ h = \frac{{P}_{c 3 , m ax} {r}_{c 3} - {P}_{c 2 , m ax} {r}_{c 2}}{( {r}_{c 3} - {r}_{c 2} ) ρ g} - \frac{2 ( {r}_{c 3} - {r}_{c 2} )}{3} & [ Equation 4 ]\end{matrix}$$

The detecting device 100 may detect at least one of the density, oil level, or surface tension of the oil based on results of the pressure measurement through the plurality of capillary tubes 111 and calculation through [Equation 1] to [Equation 4].

The detecting device 100 may be provided at a compressor in which oil is accommodated so as to detect the condition of the oil. Further, the detecting device 100 may be applied to the compressor 10 according to embodiments.

The compressor 10 according to embodiments may be a reciprocating, rotary, scroll, or vane type compressor having the detecting device 100 that detects the condition of the oil.

The compressor 10 according to embodiments includes, as illustrated in FIG. 1, the casing 11 having a hermetically sealed inner space, the oil storage portion 15 provided at the inner space of the casing 11 to accommodate oil therein, and the detecting device 100 that detects the condition of the oil accommodated in the oil storage part 15. The detecting device 100 may be installed at a position at which the oil storage portion 15 is located so as to allow the condition of the oil to be detected.

In the compressor 10 including the detecting device 100, the electric motor unit 12 that generates a rotational force may be installed at the inner space of the casing 11, and the compression unit 13 that compresses a refrigerant may be installed above the electric motor unit 12. The electric motor unit 12 and the compression unit 13 may be coupled by the crankshaft 14 so that a rotational force of the electric motor unit 12 is transmitted to the compression unit 13, allowing the compression unit 13 to be driven.

The casing 11 may be formed in a cylindrical shape with both upper and lower ends open, and the oil storage portion 15 in which oil is stored may be provided at a lower space of the casing 11. As for the compressor 10 having such a configuration, the detecting device 100 may detect oil stored in the oil storage portion 15 provided at a lower portion of the inner space of the casing 11.

As illustrated in FIG. 2, the detecting device 100 may include sensing unit or sensor 110 having the plurality of capillary tubes 111 located at the inner space of the casing 11 of the compressor 10 in which a predetermined or specific amount of oil is received to be in contact with the oil, regulating unit or regulator 120 that is connected to each of the plurality of capillary tubes 111 and controls pressure of the plurality of capillary tubes 111 so as to allow the oil to be introduced into the plurality of capillary tubes 111, and detection unit or detector 130 electrically connected to the sensing unit 110 and the regulating unit 120 to measure the pressure of the plurality of capillary tubes 111, which is adjusted by the regulating unit 120, so as to detect the condition of the oil based on results of the pressure measurement.

Alternatively, the detecting device 100 may include, as illustrated in FIG. 2, sensing unit or sensor 110 that includes the plurality of capillary tubes 111 horizontally disposed at the inner space of the casing 11 of the compressor 10 in which a predetermined amount of oil is accommodated to be in contact with the oil and the terminal 112 insertedely coupled to one surface of the casing 11 in a manner of penetrating through the one surface of the casing 11 so as to be connected to the plurality of capillary tubes 111 at the inner space, regulating unit or regulator 120 connected to each of the plurality of capillary tubes 111 through the terminal 112 to adjust or control pressure of the plurality of capillary tubes 111 so that the oil is introduced into the plurality of capillary tubes 111, and detection unit or detector 130 electrically connected to the plurality of capillary tubes 111 and the regulating unit 120 through the terminal 112 to measure the pressure of the plurality of capillary tubes 111, which is adjusted by the regulating unit 120, so as to detect the condition of the oil based on results of the pressure measurement.

That is, embodiments of the detecting device 100 described above may be applied to the compressor 10, and the compressor 10 may detect the condition of oil accommodated in the casing 11 according to the embodiments of the detecting device 100.

Embodiments have been described, but it will be understood by those skilled in the art that various changes and modifications may be made therein without departing from the scope. Therefore, the scope should not be limited by the described embodiments, but should be determined by the scope of the appended claims and equivalents thereof.

As features may be embodied in several forms without departing from characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

1. An oil detecting device for a compressor, comprising:
a sensor including a plurality of capillary tubes disposed at an inner space of a casing of the compressor in which a predetermined amount of oil is accommodated, the plurality of capillary tubes being in contact with the oil;
a regulator connected to each of the plurality of capillary tubes to adjust a pressure of the plurality of capillary tubes so that the oil is introduced into the plurality of capillary tubes; and
a detector electrically connected to the sensor and the regulator to measure the pressure of the plurality of capillary tubes, adjusted by the regulator, so as to detect a condition of the oil based on results of the measured pressure.

2. The device of claim 1, wherein an end of at least one of the plurality of capillary tubes has a different height or depth based on an oil level of the oil.

3. The device of claim 1, wherein at least one of the plurality of capillary tubes has a smaller inner diameter than the other capillary tubes of the plurality of capillary tubes.

4. The device of claim 1, wherein at least two capillary tubes of the plurality of capillary tubes have different inner diameters than the other capillary tubes of the plurality of capillary tubes.

5. The device of claim 4, wherein the plurality of capillary tubes is formed such that a capillary tube having a smaller inner diameter has a smaller depth with respect to the oil level than a capillary tube having a larger inner diameter.

6. The device of claim 1, wherein the plurality of capillary tubes is disposed in a horizontal or vertical direction with respect to an oil level of the oil.

7. The device of claim 1, wherein the regulator comprises:
a pump configured to adjust the pressure of the plurality of capillary tubes; and
a valve configured to control a flow path that connects the pump and the sensor.

8. The device of claim 7, wherein the valve selectively controls flow paths connecting the pump and the respective capillary tubes.

9. The device of claim 1, wherein the detector is configured to control the pressure by controlling operation of the regulator.

10. The device of claim 1, wherein the detector includes a measuring portion that measures the pressure of the plurality of capillary tubes.

11. The device of claim 1, wherein the detector is configured to detect at least one of a density, an oil level, or a surface tension of the oil by analyzing results of the measured pressure of the plurality of capillary tubes.

12. An oil detecting device for a compressor, comprising:
a plurality of capillary tubes horizontally disposed at an inner space of a casing of the compressor in which a predetermined amount of oil is accommodated, the plurality of capillary tubes being in contact with the oil;
a terminal insertedly coupled to one surface of the casing and penetrating through the one surface of the casing, so as to be connected to the plurality of capillary tubes at the inner space;
a regulator connected to each of the plurality of capillary tubes through the terminal to adjust a pressure of the plurality of capillary tubes so that the oil is introduced into the plurality of capillary tubes; and
a detector electrically connected to the plurality of capillary tubes and the regulator through the terminal to measure the pressure of the plurality of capillary tubes, adjusted by the regulator, so as to detect a condition of the oil based on results of the measured pressure.

13. The device of claim 12, wherein the plurality of capillary tubes is connected to the terminal at a predetermined height.

14. The device of claim 12, wherein the plurality of capillary tubes is connected to the terminal at a same height from a bottom surface of the casing.

15. The device of claim 12, wherein the terminal is inserted into the inner space by penetrating through a coupling groove formed on the one surface of the casing.

16. The device of claim 15, wherein the terminal is formed in a shape that matches the coupling groove so as to allow the inner space to be hermetically sealed when coupled to the one surface of the casing.

17. The device of claim 12, wherein the terminal is configured such that a portion thereof protruding into the inner space is connected to the plurality of capillary tubes and a portion thereof exposed to an outside of the casing is connected to the regulator when coupled to the one surface of the casing, so as to allow the plurality of capillary tubes and the regulator to be connected to each other.

18. A compressor, comprising:
a casing having a hermetically sealed inner space;
an oil storage portion provided at an inner space of the casing to accommodate oil therein; and
an oil detecting device that detects a condition of the oil accommodated in the oil storage portion, wherein the oil detecting device comprises:
a sensor including a plurality of capillary tubes disposed at the inner space of the casing, the plurality of capillary tubes being in contact with the oil;
a regulator connected to each of the plurality of capillary tubes to adjust a pressure of the plurality of capillary tubes so that the oil is introduced into the plurality of capillary tubes; and
a detector electrically connected to the sensor and the regulator to measure the pressure of the plurality of capillary tubes, adjusted by the regulator, so as to detect the condition of the oil based on results of the measured pressure.

19. The compressor of claim 18, further comprising a terminal insertedly coupled to one surface of the casing in a manner of penetrating through the one surface of the casing, so as to be connected to the plurality of capillary tubes and the regulator at the inner space.

20. The compressor of claim 18, wherein the plurality of capillary tubes is connected to the terminal at a same height from a bottom surface of the casing.
